(19) United States
(12) Patent Application Publication
(10) Pub. No.: US 2002/0024672 A1
(43) Pub. Date: Feb. 28, 2002

(54) Flame photometric detector

(75) Inventor: Shigeaki Shibamoto, Kyoto-shi (JP)

Correspondence Address: KANESAKA AND TAKEUCHI, 1423 Powhatan Street, Alexandria, VA, 22314, US

(73) Assignee: SHIMADZU CORPORATION

(21) Appl. No.: 09/888,408

(22) Filed: Jun. 26, 2001

(30) Foreign Application Priority Data
Jul. 11, 2000 (JP) 2000-209217

(51) Int. Cl. G01N 21/73

(52) U.S. Cl. 356/417; 356/315

(57) ABSTRACT

In a flame photometric detector, an upper end of a nozzle for providing a mixed gas of a column outflow gas (sample) and a fuel gas is located at a position higher than an ejection port for a combustion supporting gas disposed around the upper end of the nozzle. The mixed gas is spouted from the upper end of the nozzle, and the combustion supporting gas is spouted from the ejection port to supply oxygen. According, light emission for causing noise resulting from impurities in the combustion supporting gas occurs at a lower side of the flame, and emission of light resulting from the components in the sample occurs at an upper side of the flame. Thus, the lights can be separated easily to measure the sample accurately.

### BACKGROUND OF THE INVENTION AND RELATED ART STATEMENT

The present invention relates to a flame photometric detector in a gas chromatograph.

A flame photometric detector (hereinafter abbreviated as FPD) is a detector for a gas chromatograph, which has a high sensitivity selectively to compounds of sulfur and phosphorus.

FIG. 3 shows a sectional view of an example of a conventional FPD. In FIG. 3, reference numerals 1 through 3 designate gas chromatograph passages connected to the FPD. Namely, a carrier gas adjusted under a constant pressure or in a constant flow rate is introduced from a carrier gas introducing section 1, and passes through a sample injection port 2 and a column 3 to flow into a detector (FPD cell) 4. A sample injected from the sample injection port 2 is separated into respective components while passing through the column 3 together with the carrier gas. Hereinafter, a mixed gas formed of the carrier gas flowing from a terminal end of the column 3 and separated sample components is referred to as a column outflow gas.

In the FPD cell 4, hydrogen as a fuel gas and air as a combustion supporting gas are introduced respectively through pipes 51 and 61. Introduced hydrogen passes through a fuel gas passage extending along a central axis of a base of the FPD cell 4 in a cylinder form, to flow upwardly. An upper end of the fuel gas passage 5 forms a nozzle 7 opening toward a combustion chamber 42. The terminal end of the column 3 is inserted from a lower side of the FPD cell 4 into the fuel gas passage 5, and is fixed by a nut 31 and a ferrule 32. The combustion supporting gas passes through a combustion supporting gas passage or auxiliary passage 62 provided to surround the fuel gas passage 5, and is ejected into the combustion chamber 42 from a combustion supporting gas injection port 6 formed of a plurality of small apertures, which is disposed around the nozzle 7 and opened on the same plane as that of the nozzle 7. Incidentally, the combustion supporting gas injection port 6 may be formed as a space in a slit form annularly surrounding the nozzle 7.

The combustion chamber 42 is a space above the nozzle 7 covered by a cell outer cylinder 41, and in the combustion chamber 42, the fuel gas reacts with oxygen in the combustion supporting gas and burns to form a flame 8. An exhaust gas after the combustion is ejected from an exhaust port 43 at an upper portion of the cell outer cylinder 41.

The column outflow gas is mixed with the fuel gas inside the fuel gas passage 5 and is ejected into the flame 8 from the nozzle 7. If the sample contains components including sulfur and phosphorus, light with a specific wavelength is emitted in the high-temperature flame 8. A luminous intensity of this light is measured by a photometry section 10 disposed at a side of the flame 8. Namely, the light emitted from the flame 8 passes through a quartz window 13 to enter into the photometry section 10, and passes through an interference filter 11, which allows only the specific wavelength as a measurement object to pass therethrough, to be changed to an electric signal at a photomultiplier 12. The electric signal is outputted to an external measuring circuit, not shown.

Generally, in order to increase the sensitivity of the detector, that is, in order to lower a detection lower limit, it is necessary to increase the signal-to-noise ratio by decreasing the noise. One of the causes for the noise in the conventional FPD is an emission of light resulting from impurities in the combustion supporting gas (air). Since there are so many impurities in air having relatively low molecular weight, there are many impurities instantly emitting lights in the hydrogen flame without a step, such as pyrolysis. Therefore, many impurities in the combustion supporting gas flowing toward the flame 8 from a lower side thereof emit light at the lower side of the flame 8. In other words, the light emitted from the lower side of the flame contains a lot of noises. Thus, it is considered that the noise can be decreased if the emission of light from the lower side of the flame (hereinafter referred to as a noise light emission) is cut.

From the foregoing, heretofore, a shielding ring 9 made of metal is provided around a plane, in which the nozzle 7 and the supporting gas injection port 6 exist, such that the light emitted from the lower side of the flame 7 is prevented from entering into the photometry section 10 located at the side of the flame. This shielding ring 9 is structured to be able to adjust a position thereof in the vertical directions, to thereby set the shielding ring 9 at an optimal position. However, if the position of the shielding ring 9 is too high, light emitted at an upper side of the flame 8 for providing the sample components is also shielded, resulting in decreasing the sensitivity. On the contrary, if the position of the shielding ring 9 is too low, the meaning of providing the shielding ring 9 is lost. Namely, the shielding ring 9 requires a very delicate adjustment. However, in reality, since the shielding ring 9 is located inside the cell, it is very difficult to conduct a minute adjustment. Accordingly, as the case stands, the shielding ring 9 does not always function effectively.

The present invention has been made in view of the foregoing, and an object of the invention is to provide a fuel photometric detector which has a structure suitable for separating and shielding the light emission for causing noise, to thereby decrease the noise in the FPD, resulting in improving the signal-to-noise (S/N) ratio.

Further objects and advantages of the invention will be apparent from the following description of the invention.

### SUMMARY OF THE INVENTION

To achieve the aforementioned object, the present invention provides a flame photometric detector having an FPD cell, in which an upper end of a nozzle for spouting a mixed gas of a column outflow gas (sample) and a fuel gas is located above a combustion supporting gas injection port disposed around the upper end of the nozzle. The column outflow gas joins the fuel gas (hydrogen) inside a fuel gas passage, and the mixed gas is spouted from the nozzle to form a flame. The combustion supporting gas (air) flows through a combustion supporting gas passage or auxiliary passage to be spouted from the injection port, to thereby supply oxygen necessary for combustion to the flame. The flame mainly formed of hydrogen with the higher diffusion velocity is spread even to the lower side of the flame to surround the nozzle. Therefore, the light emission for causing noise resulting from the impurities in the supporting gas supplied from the lower side of the nozzle occurs at a portion of the flame lower than the nozzle, so that the light emission for causing noise is separated easily from the emission of the light resulting from the sample components mainly occurred at the upper side of the flame.

In addition, depending on the structural design of the cell, it is possible to cut the light emission for causing noise without using the shielding ring, and the structure of the FPD cell can be simplified.

### BRIEF DESCRIPTION OF THE DRAWINGS

FIG. 1 is a schematic sectional view showing an embodiment of the invention;

FIGS. 2(A) through 2(C) are diagrams of experimental data showing effects of the invention, wherein FIG. 2(A) shows a measurement result by a conventional FPD; FIG. 2(B) shows a measurement result by an FPD of the present invention; and FIG. 2(C) shows comparison results between the conventional FPD and the FPD of the invention; and

FIG. 3 is a partly sectional, schematic view showing a structure of a conventional FPD.

### DETAILED DESCRIPTION OF PREFERRED EMBODIMENTS

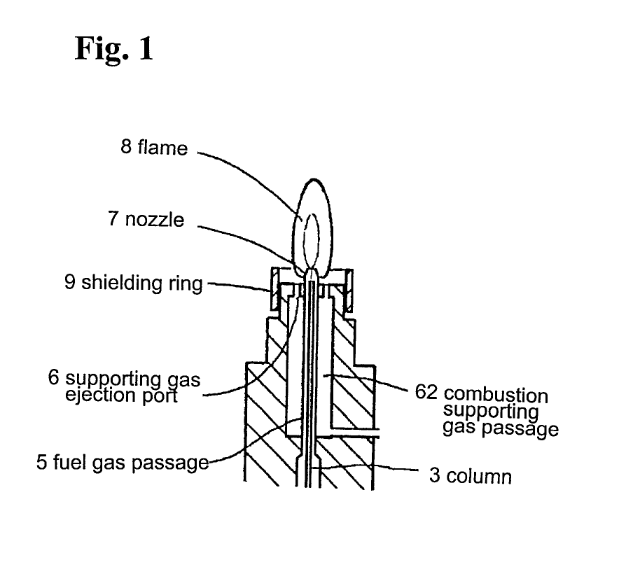

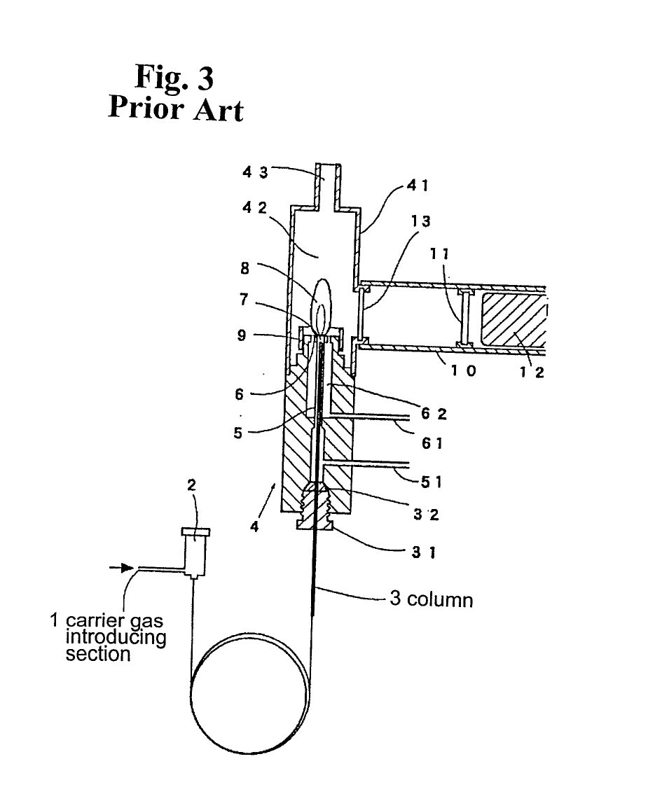

An embodiment of the present invention is shown in FIG. 1. In FIG. 1, only a nozzle inside an FPD cell and a part around the nozzle are shown, and parts not shown in the figure are the same as those in FIG. 3.

In FIG. 1, a column outflow gas joins a fuel gas (hydrogen) inside the fuel gas passage 5, and is ejected from the nozzle 7 and combusted, to thereby form flame 8. On the other hand, a combustion supporting gas (air) flows through a combustion supporting gas passage or auxiliary passage 62, and is ejected from the combustion supporting gas ejection port 6, so as to supply oxygen necessary for combustion to the flame 8.

The embodiment of the invention is different from the conventional structure in that a distal end of the nozzle 7 projects at a side above the surface including the combustion supporting gas injection port 6. According to this structure, after hydrogen having a higher diffusion velocity is spouted from the nozzle 7, although most of hydrogen is directed upwardly, a part of hydrogen diffuses at a lower side of the nozzle 7. Thus, the flame 8 is spread even to the lower side of the nozzle 7 such that the flame 8 surrounds the nozzle 7. Therefore, the emission of light resulting from the impurities in the combustion supporting gas supplied from a side lower than the nozzle 7 occurs mainly at a portion of the flame lower than the nozzle 7. On the other hand, the sample components mixed with hydrogen and spouted from the nozzle 7 have a lower diffusion velocity as compared with hydrogen. Therefore, the sample components do not substantially move or flow to the lower section of the nozzle 7. In addition, there is a time-lag until the emission of light occurs because of the molecular weights, so that the emission of light resulting from the sample components mainly occurs at the upper side of the flame.

Namely, the emission of light for causing noises and the emission of light resulting from the sample components are separated respectively at the upper side of the flame and the lower side thereof. Although this kind of the separation has been known conventionally as described above, the separation occurs in the distinct form according to the present invention. As a result, it becomes easy to shield the light emission for causing noises by the shielding ring 9 disposed around the supporting gas injection port 6, and the vertical position of the shielding ring 9 is not required to be adjusted precisely.

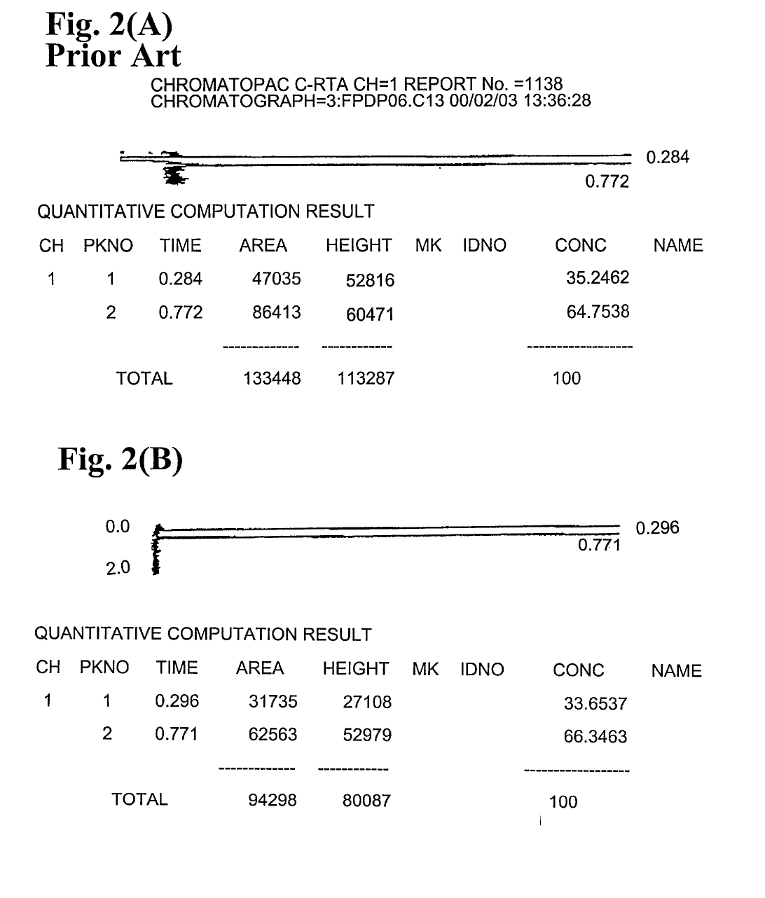

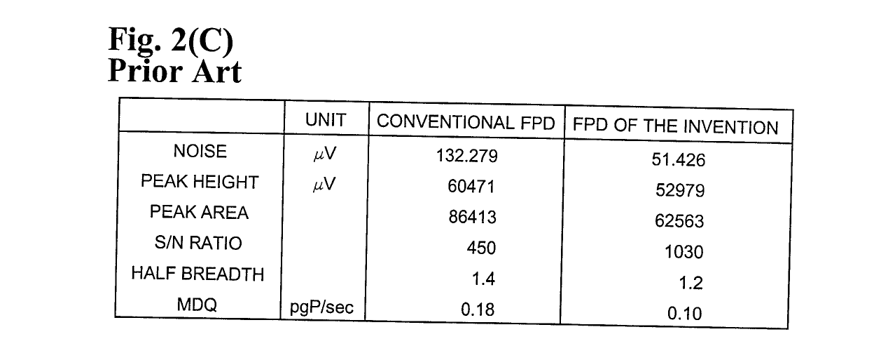

FIGS. 2(A) through 2(C) show effects of the FPD of the invention by experimental data.

In this experiments, hexane dilution of tri-n-butyl phosphate (concentration thereof is 10 ppm) is used as the sample to conduct the gas chromatograph analysis, and detected by using the conventional FPD and the FPD of the present invention, to compare the results with each other.

FIG. 2(A) shows a measurement result by the conventional FPD in which the nozzle and the air injection port are located at the same horizontal level, and FIG. 2(B) shows a measurement result by the FPD of the invention, in which the nozzle is located at a position 2 mm higher than the air injection port, under the same condition as in the conventional FPD. As indicated in the comparison results shown in FIG. 2(C), the FPD of the invention exhibits improved effects such that the signal-to-noise ratio and MDQ (minimum detection quantity) in the FPD of the invention are approximately twice as those in the conventional FPD.

Incidentally, setting conditions of the gas chromatograph in the experiment are as follows:

| Column: | CBN1-M15-25 |
|---|---|
| Temperature in the column: | 180° C. |
| Temperature in the detector: | 250° C. |
| Carrier gas: | helium, 2.5 ml/min |
| Split ratio: | 1:19 |

According to the present invention, the light emission for causing noise is separated positionally well in the flame from the emission of the light caused by the sample components. Therefore, even if the shielding ring 9 in FIG. 1 is omitted, by adequately designing the position of the photometry section 10 so as to prevent the emission of the light from the lower side of the flame from entering into the photometry section, it is possible to cut the light emission for causing noise. Namely, the shielding ring 9 is not always necessary in view of the structure of the invention, and the function of the shielding ring can be substituted by other means which can be easily thought of as the designing matter.

Incidentally, although hydrogen is used as the fuel gas and air is used as the combustion supporting gas in the above explanation of the embodiment, there is a possibility of using other gases.

Accordingly, since the FPD of the present invention is structured as described above, the light emission for causing noise and the light emission from the sample components are separated well at the upper and lower sides of the flame. As a result, it becomes easy to shield the light emission for causing noise, so that the noise can be reduced, resulting in improving the signal-to-noise ratio.

While the invention has been explained with reference to the specific embodiments of the invention, the explanation is illustrative and the invention is limited only by the appended claims.

What is claimed is:

1. A flame photometric detector for measuring a luminous intensity of light, comprising:
a cell having a base with an upper end surface and a combustion chamber located above the base for burning a mixture of a column outflow gas and a fuel gas, and
a nozzle for burning the column outflow gas together with the fuel gas, said nozzle passing through the base to be located in the combustion chamber and having an upper end located above the upper end surface of the base so that light emission for causing noise and light emission from sample components in the column outflow gas are separated at upper and lower sides of a flame.

2. A flame photometric detector according to claim 1, wherein said base includes a fuel gas passage having said nozzle for providing the fuel gas, a column for providing the column outflow gas located inside the fuel gas passage, and an auxiliary gas passage having a gas outlet located at the upper end surface of the base below the upper end of the nozzle for providing combustion supporting gas to the fuel gas.

3. A flame photometric detector according to claim 2, wherein an upper end of the column is located slightly below the upper end of the nozzle.

4. A flame photometric detector according to claim 2, further comprising shielding means located above the base for surrounding the auxiliary gas passage and the fuel gas passage, said shielding means shielding a lower side of the flame for preventing the light emission for causing noise from effecting a measurement of a luminous intensity.

5. A flame photometric detector according to claim 4, further comprising a photometry section situated adjacent to the combustion chamber, and a photomultiplier situated adjacent to the photometry section so that the luminous intensity of the light with a specific wavelength emitted by the flame can be measured.
